(19) United States
(12) Patent Application Publication
(10) Pub. No.: US 2006/0136944 A1
(43) Pub. Date: Jun. 22, 2006

(54) Disc-conveying structure of a slot-in optical disc device

(75) Inventors: Chang-Chih Tsai, Sanchong City (TW); Hui-Chun Wang, Chung Ho City (TW)

Correspondence Address: NIKOLAI & MERSEREAU, P.A., 900 SECOND AVENUE SOUTH, SUITE 820, MINNEAPOLIS, MN, 55402, US

(73) Assignee: Ultima Electronics Corp., Chung Ho City (TW)

(21) Appl. No.: 11/021,813

(22) Filed: Dec. 22, 2004

(51) Int. Cl. G11B 17/04; G11B 17/03

(52) U.S. Cl. 720/619; 720/656

(57) ABSTRACT

A disc-conveying structure of slot-in optical disc device, mainly an optical disc device for optical disc, includes a switch device, cooperating with the action of the optical disc to start or close the procedure of disc-conveying; a roller device, which is a cylindrical roller pivotally connected to a main chassis of the optical disc device and formed as conveying device with driving of a motor; and a clamping device, which is a caging mechanism for optical disc and enables the optical disc to be conveyed to the correct working area so as to be accessed successfully by the disc read/write head.

### BACKGROUND OF THE INVENTION

1. Field of the Invention

The present invention relates to a disc-conveying structure of a slot-in optical disc device, and more particularly, to a slot-in optical disc device providing a conveying mechanism and a positioning mechanism to load, operate and eject the optical storage media disc.

2. Description of Related Art

A conventional slot-in optical disc device, such as DVD-ROM, VCD-ROM, CD-ROM and onboard audio system, is provided with a sensor to automatically detect the insertion of an optical disc in the loading slot and start the conveying mechanism and procedure thereof.

Nowadays there are two main types of optical discs, i.e. 8-cm diameter disc and 12-diameter disc, but the slot-in optical disc device is usually designed for 12-cm diameter disc, not for 8-cm diameter disc. According to public technical literatures, it is known that through detecting the loading of the disc by optical sensors or two pairs of optical interceptors, the optical disc device is able to determine whether the disc is an 8-cm diameter disc or a 12-cm diameter disc. The device then is able to control a clamping/conveying device to hold and convey the optical disc according to different types of discs. There is another type of slot-in optical disc device having the similar structure as that mentioned above, but the principle of the technology is based on the time difference with which discs of different dimensions pass over the optical sensors. Furthermore, there is another different technology disclosed to determine the dimension of the disc passing through the optical sensor, which is related to the technology of the present invention. However, detailed description thereof is not going to be addressed hereinafter for brevity.

According to the aforementioned discussion, it is noted that none of the above patents is able to use the same clamping device to pickup discs of different dimensions. Therefore, the structure in the patents is complicated and thus the manufacture cost thereof is high.

### SUMMARY OF THE INVENTION

The present invention is directed to a disc-conveying structure of slot-in optical disc device to resolve one or even more restrictions and deficiencies described above in prior art.

It is therefore that an objective of the present invention is to provide a switch device in mechanism form to start or close the optical disc-conveying procedure.

Another objective of the present invention is to provide a clamping device in mechanism form to clamp an 8-cm diameter disc which is shorter than the width of the loading slot to the correct working area of the disc read/write head, even though the disc is not put in the center of the loading slot. With the same mechanism, the 8-cm diameter disc or the 12-cm diameter disc can be positioned and ejected from the optical disc device.

To attain the disc-conveying structure of slot-in disc device, an optical disc device at least comprises a switch device, which is a mechanism to start or close the optical disc-conveying procedure according to the action of the optical disc; a roller device, which is a cylindrical rod pivotally connected to a main chassis of the optical disc device, and with driving of a motor, is formed as a conveying device for optical disc; and a clamping device, which is a caging mechanism for the optical disc to restrict the optical disc to be put in the correct working area such that the optical disc can be accessed successfully by the disc read/write head.

Other and further features, advantages and benefits of the invention will become apparent in the following description taken in conjunction with the following drawings. It is to be understood that the foregoing general description and following detailed description are exemplary and explanatory but are not to be restrictive of the invention. The accompanying drawings are incorporated in and constitute a part of this application and, together with the description, serve to explain the principles of the invention in general terms. Like numerals refer to like parts throughout the disclosure.

### BRIEF DESCRIPTION OF THE DRAWINGS

FIG. 1 is a plan view showing the main structure of an embodiment of the invention;

FIG. 2 is a perspective view of an embodiment of the invention related to FIG. 1;

FIG. 3 is a perspective view showing a switch device of an embodiment of the invention;

FIG. 4 is a schematic view showing the loading of an optical disc in the loading slot;

FIG. 5 is a perspective view showing a clamping device of an embodiment of the invention;

FIG. 6 is a schematic view showing an optical disc in the working area;

FIG. 7 is a schematic view showing the ejection of a 12-cm diameter disc;

FIG. 8 is a schematic view showing the loading of an 8-cm diameter disc; and

FIG. 9 is a schematic view showing the ejection of an 8-cm diameter disc.

### DETAILED DESCRIPTION OF THE PREFFERED EMBODIMENT

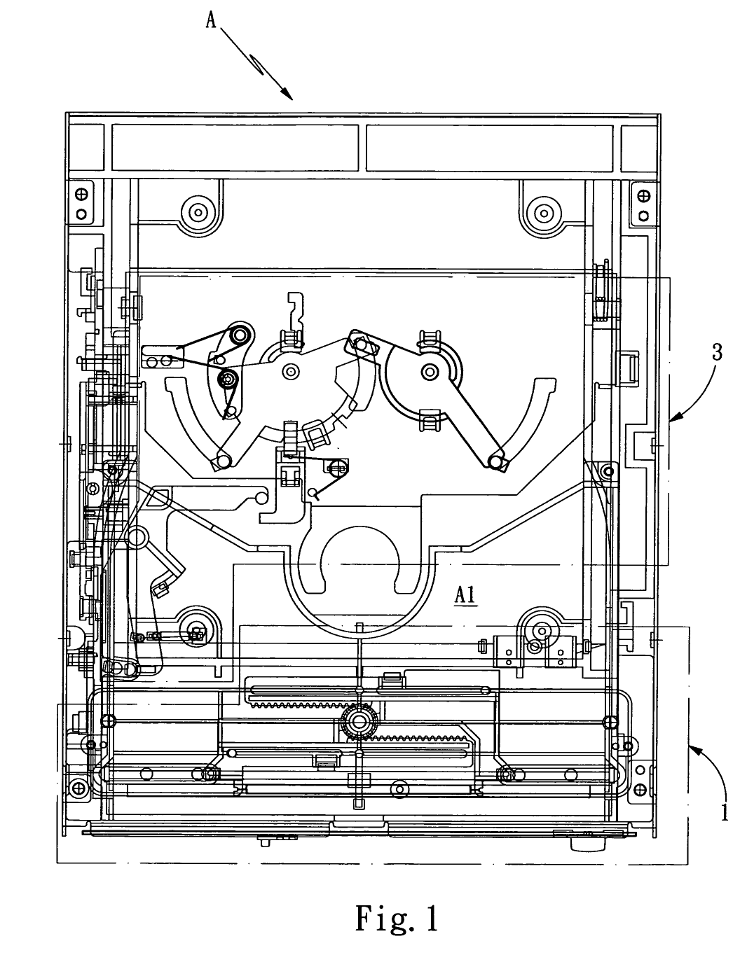

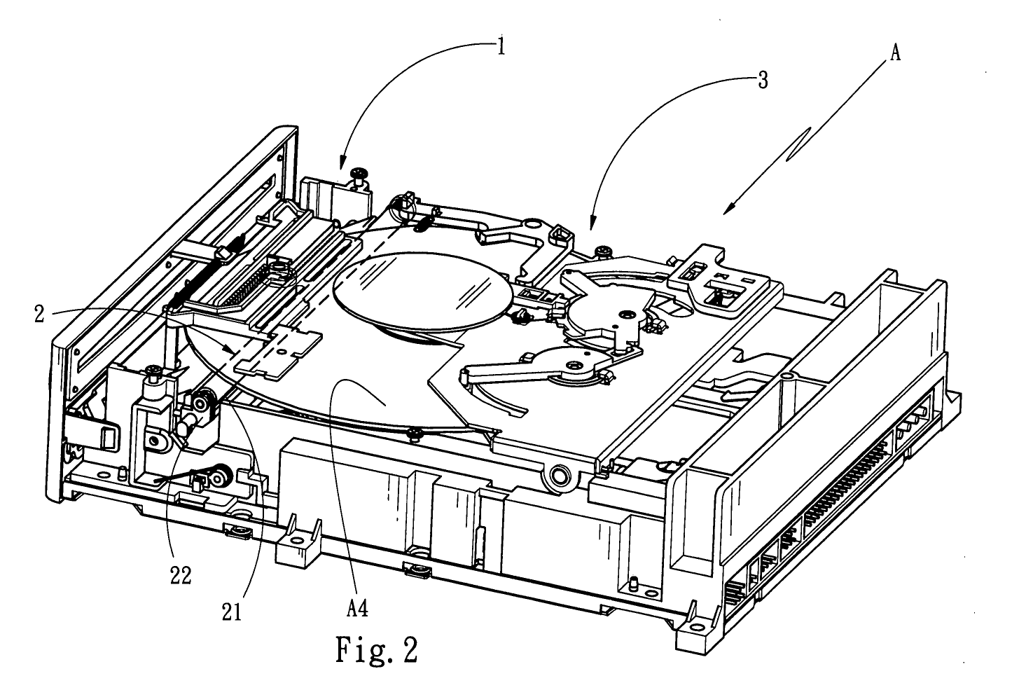

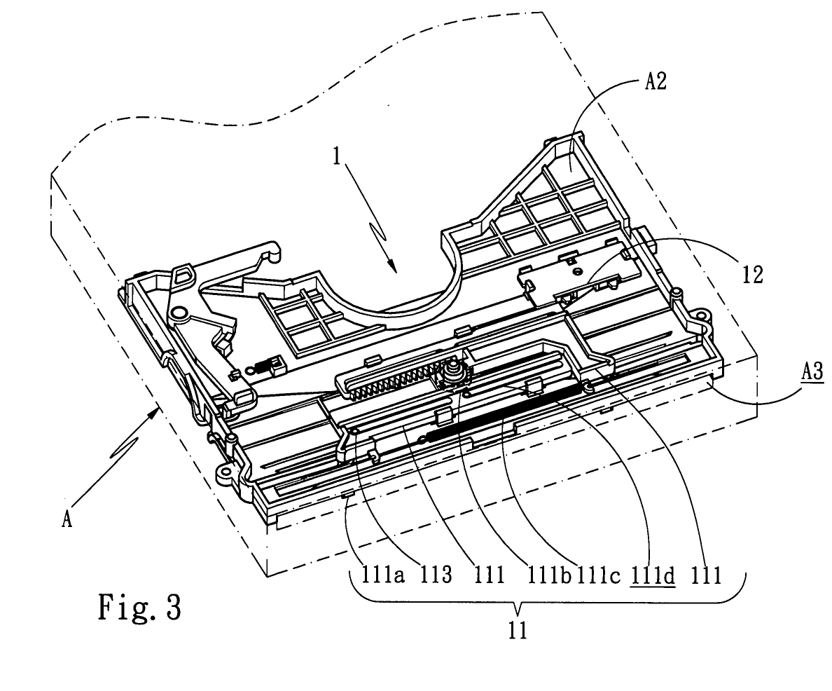

With reference to FIG. 1 and FIG. 2, it is a type of optical disc device A, such as a DVD-ROM, a VCD-ROM, a CD-ROM or an onboard audio system for optical discs, comprising at least a switch device 1; a roller device 2; and a clamping device 3. All of the devices are placed on a main chassis A2 (shown in FIG. 3) of the optical disc device A. The switch device 1 can start or close the optical disc-conveying procedure; the roller device 2 is a conveying device with driving of a motor; and the clamping device 3 is a caging mechanism for an optical disc A4 to restrict the optical disc A4 to be located in a specific working area A1 such that the optical disc A4 can be accessed successfully by the disc read/write head.

As shown in FIG. 2, the roller device 2 includes a cylindrical roller 21 and a brace 22. The cylindrical roller 21 is pivotally connected to the brace 22 of the optical disc device A and is formed as a conveying device with driving of the motor (not shown in figures).

With reference to FIG. 3, the switch device 1 includes a lock gate mechanism 11 and a limit switch 12 respectively disposed on the loading slot A3 of the main chassis A2 of the optical disc device A.

The lock gate mechanism 11 has a plurality of guiding arms 111, and at one end of each guiding arm 111 a clamping bar 111a is extendedly formed at a certain angle to cooperate with the insertion of the optical disc A4 and the clamping bars 111a are located in opposite ends of the guiding arms. In the preferred embodiment, the angle is vertically downward. Moreover, each guiding arm 111 has grooves to mesh with a spur gear 111b pivotally connected to an appropriate location of the main chassis A2. At least one guiding arm 111 is connected to an elastic element 111c, which provides an elastic recovery force on the guiding arm 111 to retain the tendency of the guiding arm 111 toward unexpanded state when the guiding arm 111 is expanded. Guiding holes 111d are defined in the guiding arms 111 and parallel to slip directions of the guiding arms 111. A plurality of columns 113 mounted on the main chassis A2 pass into the guiding holes 111d respectively to restrict the guiding arms 111 to slip separately in opposite directions so as to avoid interference during expanding process, and the slip directions of the guiding arms 111 are confined to nearly parallel to the loading slot A3.

The limit switch 12 mounted on an appropriate location of the main chassis A2 is electrically connected to the on-off circuit of the roller device 2 (referring to FIG. 2). When the guiding arm 111 is expanded to a certain position, it triggers the limit switch 12 to start the motor, and then the motor drives the roller device 2 to work with mechanical connection.

Based on the description and depiction above, the switch device 1 of the present invention is able to start or close the optical disc-conveying procedure.

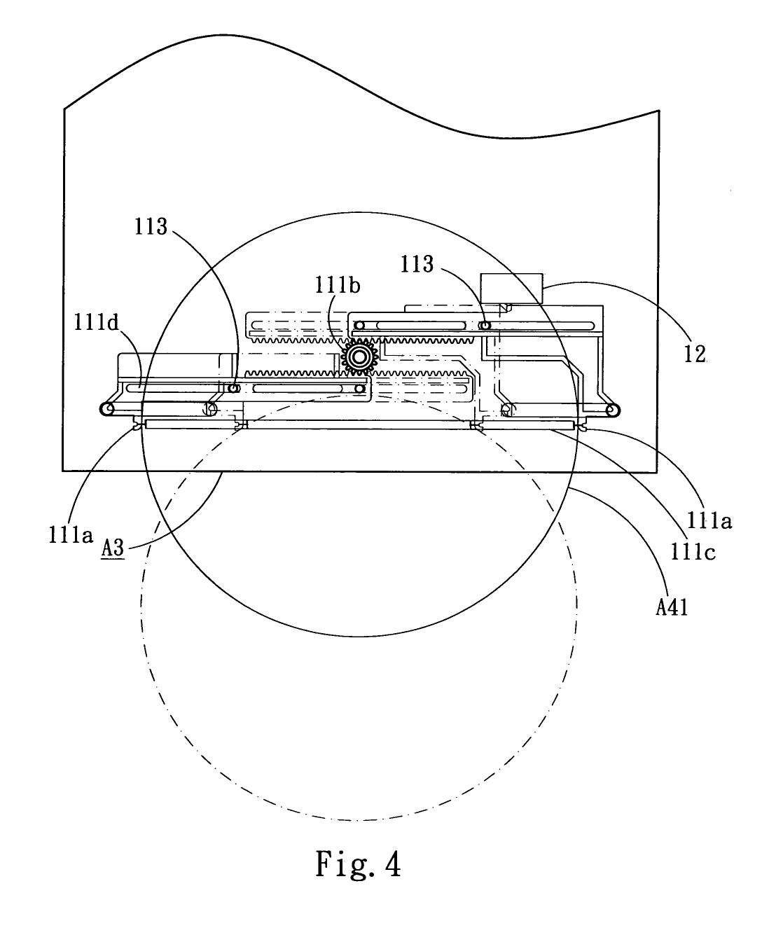

With reference to FIG. 4, when the optical disc A4 is inserted into the loading slot A3, the optical disc A4 presses the clamping bar 111a of the guiding arm 111, and then the guiding arm 111 under the restriction of the guiding hole 111d and columns 113 is expanded to a certain position to trigger the limit switch 12, which starts the motor to drive the roller device 2 to work (referring to FIG. 2). After the optical disc A4 has passed through the guiding arm 111, the guiding arm 111 draws back to the unexpanded position by the elastic recovery force of the elastic element 111c, and the limit switch 12 closes the motor to stop the roller device 2 working.

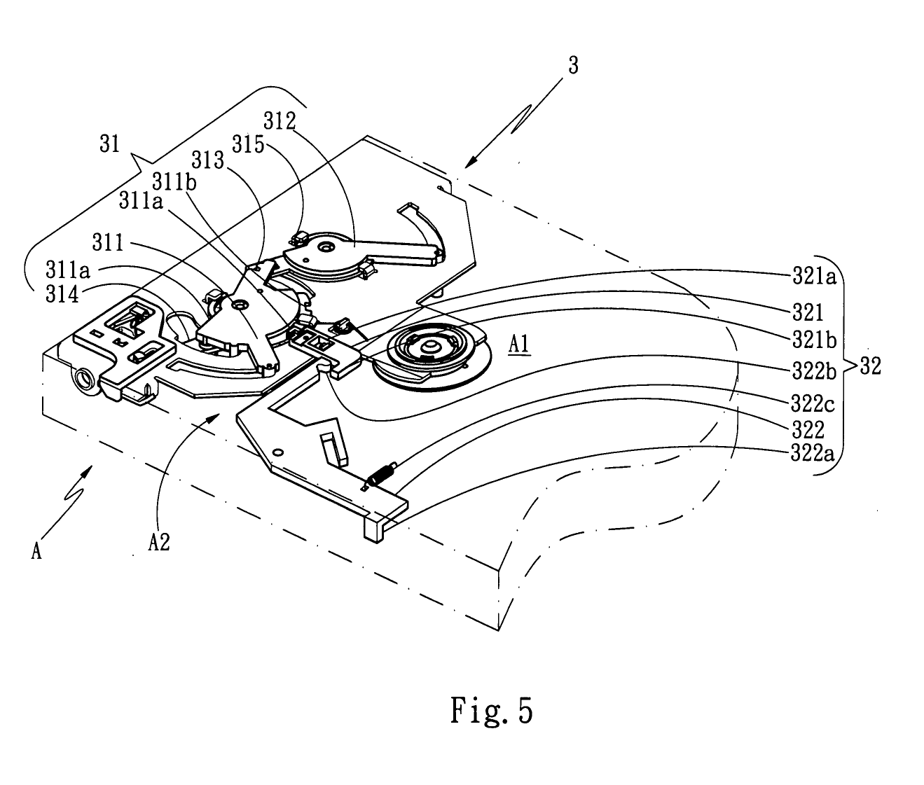

With reference to FIG. 5, the clamping device 3 includes a holding lever 31 and a locking mechanism 32 disposed on the working area A1 respectively. When the optical disc A4 is in process of conveying to working area A1, with the clamping device 3, it can be conveyed to the correct position to achieve positioning.

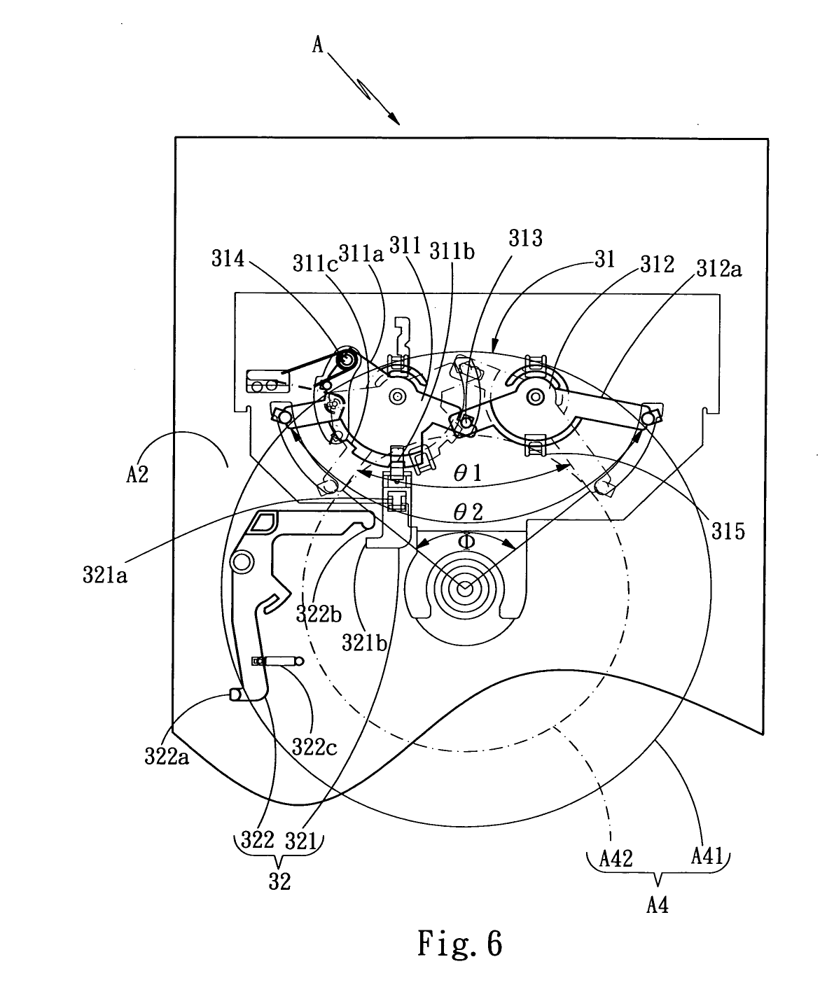

As shown in FIG. 5 and with reference to FIG. 6, the holding lever 31 has a first lever arm 311 and a second lever arm 312, both of which are disposed in the relative locations on the main chassis A2 and form an appropriate minimum included angle θ1 or an appropriate maximum included angle θ2 between them. The minimum included angle θ1 is to fit for an 8-cm diameter disc A42 lain in the working area A1 as the maximum included angle θ2 is to fit for a 12-cm diameter disc A41 lain in the working area A1. With a coupled mechanism 313 between the first lever arm 311 and the second lever arm 312, the first lever arm 311 and the second lever arm 312 are able to make relative gyratory motions synchronously.

At the pivotal locations, the first lever arm 311 and the second lever arm 312 respectively radially elongate to form sectorial areas 311a, 312a each of which has an appropriate arc angle and an arc length thereof. The sectorial area 311a of the first lever arm 311 recesses inward along radial direction to form a first groove 311b and a second groove 311c. The difference in the arc angel between the first groove 311b and the second groove 311c in the sectorial area 311a is equal to the difference in the included angle between the minimum included angle θ1 and the maximum included angle θ2. A plurality of guiding pieces 315 are mounted on the main chassis A2 in relative positions to the arcs of the sectorial areas 311a, 312a and one face of each guiding piece 315 is above and close to the sectorial area 311a or 312a such that the first lever arm 311 and second lever arm 312 can gyrate more stably under the guiding pieces 315.

At least the first lever arm 311 or the second lever arm 312 is connected to an elastic element 314 disposed on the main chassis A2, and the elastic element 314 provides an elastic recovery force on the lever arm, which retains the tendency of the lever arm toward returning to the minimum included angle θ1.

The locking mechanism 32 includes a fixing lever 321 and a drawing lever 322.

The fixing lever 321 disposed on the main chassis A2 is designed to cooperate with the first lever arm 311. One end of the fixing lever 321 is initially held in the first groove 311b of the sectorial area 311a of the first lever arm 311, and a flange 321b is formed on a lateral side of the fixing lever 321. The fixing lever 321 is connected to an elastic element 321a disposed on the main chassis A2 and the elastic element 321a provides an elastic recovery force on the fixing lever 321. The fixing lever 321, therefore, has one dimensional movement and tends to be close to the sectorial areas 311a of the first lever arm 311 in the direction of the one dimensional movement.

The drawing lever 322 pivotally connected to the main chassis A2 of the optical disc device A has a front bar 322a and a rear bar 322b. One side of the drawing lever 322 is connected to an elastic element 322c disposed on the main chassis A2 and the elastic elements 322c provides an elastic recovery force to drive the drawing lever 322 to return to its initial position. The front bar 322a of the drawing lever 322 extends to the conveying route of the optical disc. The rear bar 322b of the drawing lever 322 extends close to the flange 321b formed on the fixing lever 321.

As shown in FIG. 6, during the 12-cm diameter disc A41 being conveyed to the working area A1, at first the 12-cm diameter disc A41 widthways suppresses the front bar 322a of the drawing lever 322, and results in a lever motion so as to simultaneously make the rear bar 322b push the flange 321b to drive the fixing lever 321 to depart from the first groove 311b of the first lever arm 311. Then the 12-cm diameter disc A41 pushes the first lever arm 311 and the second lever arm 312 existing at the minimum included angle θ1 to expand until the maximum included angle θ2 is attained between the first lever arm 311 and the second lever arm 312. At that time, by the elastic recovery force of the elastic element 321a, the fixing lever 321 holds into the second groove 311c of the first lever arm 311 and makes the first lever 311 and the second lever 312 maintain the maximum included angle θ2 without the 12-cm diameter disc A41 propping up.

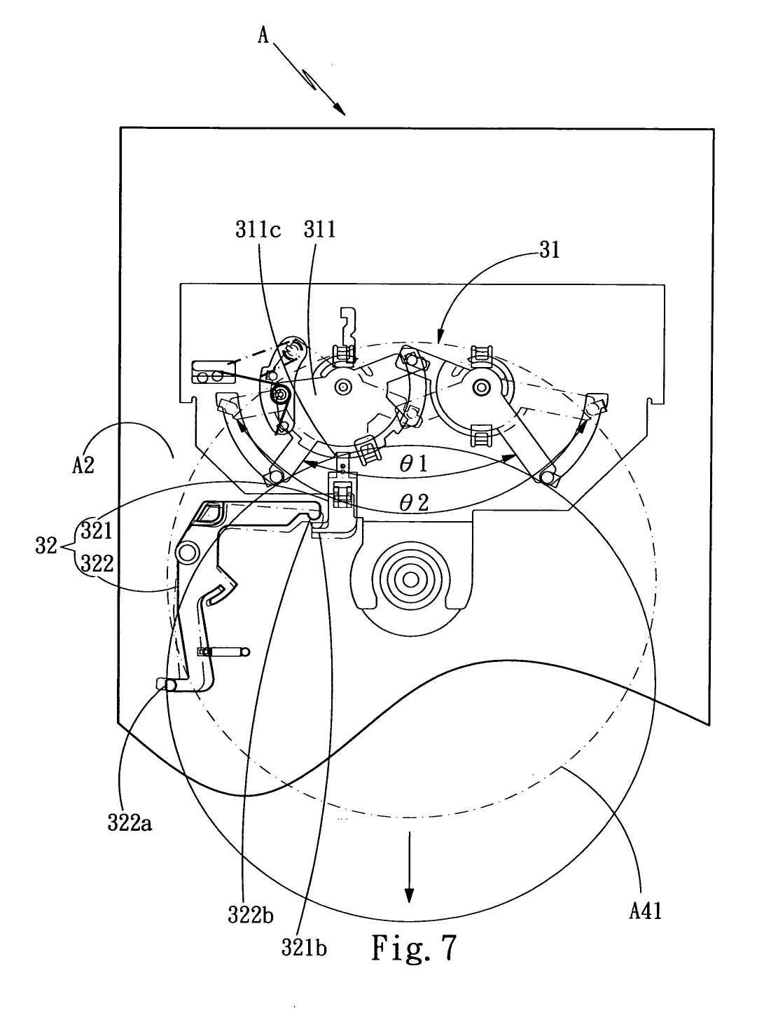

With reference to FIG. 7, when the 12-cm diameter disc A41 is ejected from the working area A1 of the optical disc device A, the 12-cm diameter disc A41 widthways suppresses the front bar 322a of the drawing lever 322 and results in a lever motion to make the rear bar 322b push the flange 321b of the fixing lever 321 and simultaneously drive the fixing lever 321 to depart from the second groove 311c of the first lever arm 311. By the effect of the elastic element 321a, the first lever arm 311 and the second lever arm 312 existing at the maximum included angle θ2 return to the initial state at the minimum included angle θ1.

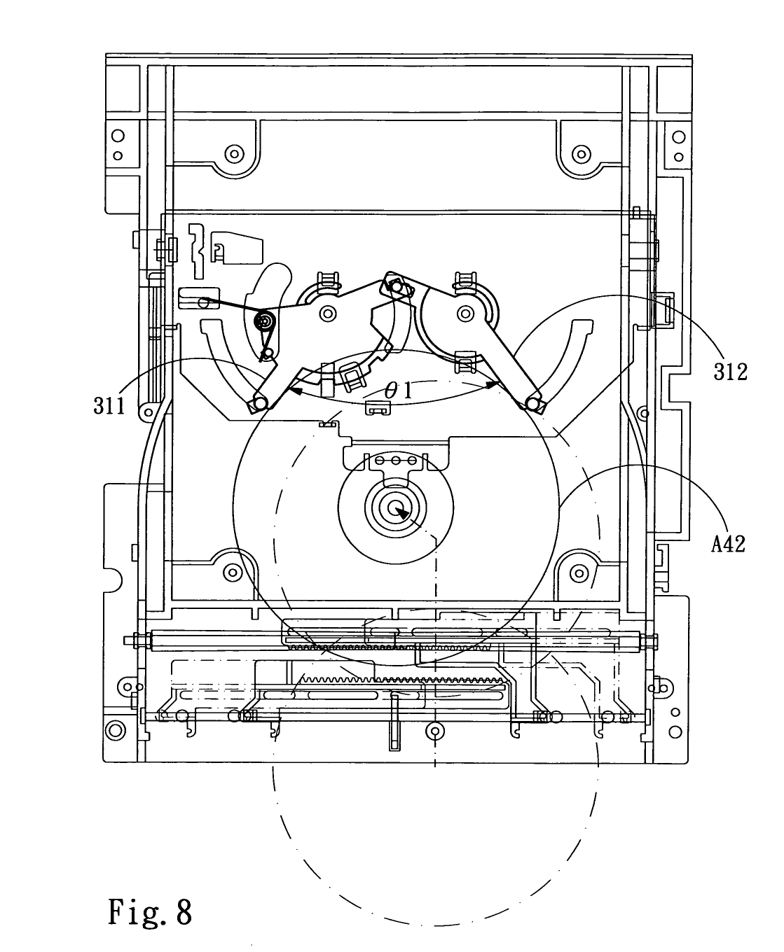

With reference to FIG. 8, in more detailed embodiment, the fixing lever 321 is initially held into the first groove 311b of the first lever arm 311, and the first lever arm 311 and the second lever arm 312 exist at minimum included angle θ1. During disc-conveying process, the 8-cm diameter disc A42 is able to be conveyed directly to the working area A1, i.e., directly to the area formed by the included angle between the first lever arm 311 and the second lever arm 312, such that the disc device A can attain the direct positioning of the 8-cm diameter disc A42. In the forementioned situation, even though the 8-cm diameter disc A4 is inserted in deviation into the loading slot A3 of the optical disc device A, and then suppresses the drawing lever 322 during disc-conveying (referring to FIG. 7), due to the smaller dimension than 12-cm, the drawing lever 322 will return to the normal position without driving the fixing lever 321 holding into the second groove 311c after the 8-cm diameter disc A4 passes through the drawing lever 322. Hence, the fixing lever 321 still holds into the first groove 311b; the first lever arm 311 and the second lever arm 312 still exist at minimum included angle θ1. Finally, the 8-cm diameter disc A42 contacts with the first lever arm 311 or the second lever arm 312, and is conveyed along the first lever arm 311 or the second lever arm 312 to the area formed by the included angle between the first lever arm 311 and the second lever arm 312. The direct positioning of the 8-cm diameter disc A42 is attained thereby.

It is the preferred condition that when the 8-cm diameter disc tangentially contacts with the first lever arm 311 and the second lever arm 312, the two tangential points form an included angle Φ (see in FIG. 6) with the center of the 8-cm diameter disc A42 as the origin of the included angle•, the included angle Φ which is complementary to minimum included angle θ1, i.e. the sum of included angle Φ and minimum included angle θ1 is 180, such that the 8-cm diameter disc A42 is not likely to be jammed by the first lever arm 311 and second lever arm 312, and hence it can push them successfully.

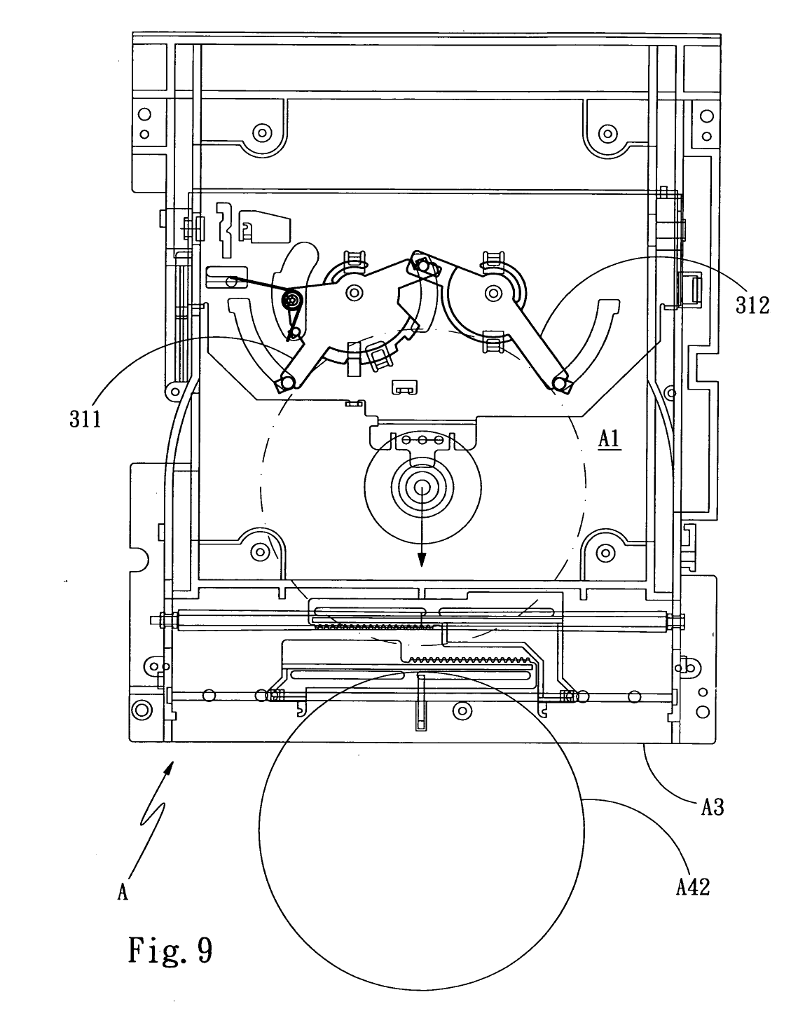

With reference to FIG. 9, when the 8-cm diameter disc A41 is ejected form the working area A1 of the optical disc device A, it is directly ejected to the loading slot A3 of the optical disc device A.

Based on the forementioned above, the clamping device of the disc-conveying structure of the slot-in optical disc device is able to accomplish the positioning of the 8-cm diameter disc and 12-cm diameter disc loaded into the disc device, and by the same mechanism, the optical disc is able to be ejected out of the disc device.

Although this invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A disc-conveying structure of slot-in disc device, mainly an optical disc device for optical disc, comprising:
a switch device cooperating with the disc-conveying action to selectively start and close the procedure of disc-conveying;
a roller device consisting of a cylindrical roller pivotally connected to a main chassis of the disc device, formed as a conveying device with driving of a motor; and
a clamping device including a holding lever and a locking mechanism, wherein the holding lever is constituted of a first lever arm and a second lever arm, each of which are disposed on the main chassis in relative locations, and the locking mechanism is driven by different dimensions of discs to control the degree of the motion range of the first lever arm and the second lever arm so as to selectively form a corresponding minimum included angle and a maximum included angle, and with a coupled mechanism between the first lever arm and the second lever arm, the first lever arm and the second lever arm make relative gyratory motions synchronously.

2. The disc-conveying structure of slot-in optical disc device according to claim 1, wherein the minimum included angle is to fit for an 8-cm diameter disc lain in the working area, as the maximum included angle is to fit for a 12-cm diameter disc lain in the working area, and at least one lever arm is connected to an elastic element disposed on the main chassis and providing an elastic recovery force on the lever arm to make the lever arm tend to return to the minimum included angle.

3. The disc-conveying structure of slot-in optical disc device according to claim 1, wherein at the pivotal location, the first lever arm radially extends to form a sectorial area that has an appropriate arc angle and an arc length thereof, and the sectorial area of the first lever arm recesses inward along radial direction to form a first groove and a second groove, and the difference in the arc angel between the first groove and the second groove in the sectorial area is equal to the difference in included angle between the minimum included angle and the maximum included angle, and the locking mechanism includes a fixing lever and a drawing lever, wherein
the fixing lever is disposed on the main chassis and connected to an elastic element disposed on the main chassis to make the fixing lever be able to do one dimensional movement, and with the one dimensional movement, the fixing lever tends to be close to the sectorial area of the first lever arm to hold in the groove of the first lever arm of the holding lever such that one end of the fixing lever is initially held in the first groove of the sectorial area of the first lever arm,
and the drawing lever pivotally connected to the main chassis of the optical disc device to form as a lever mechanism cooperates with the fixing lever, and during conveying process the optical disc suppresses one end of the drawing lever to drive the fixing lever selectively departing from the first groove and the second groove of the first lever arm.

4. The disc-conveying structure of slot-in optical disc device according to claim 1, wherein at pivotal locations the first lever arm and the second lever arm respectively radially elongate to form a sectorial area, which has an appropriate arc angle and an arc length, and in the relative position to the arc of the sectorial area, a plurality of guiding pieces are form to engage with the sectorial area to make the first lever arm and the second lever arm gyrate more stably.

5. The disc-conveying structure of slot-in optical disc device according to claim 1, wherein the switch device includes a lock gate mechanism and a limit switch respectively disposed on the loading slot of the main chassis of the optical disc device, and the lock gate mechanism is expanded by the insertion of the optical disc, and the limit switch is set up at a certain position in the expanding path of the lock gate mechanism, and with the selectively expanding and drawing back of the lock gate mechanism to trigger the limit switch, the roller device selectively starts and closes the disc-conveying procedure.

6. The disc-conveying structure of slot-in optical disc device according to claim 5, wherein the lock gate mechanism has a plurality of guiding arms, which are restricted to slip in relatively straight directions, and a plurality of clamping bars are respectively extendedly formed on the relative ends of the guiding arms such that the clamping bars is able to cooperate with the insertion of the optical disc to expand the guiding arms, and a spur gear pivotally connected to the main chassis is meshed with the guiding arms, and at least one guiding arm is connected to an elastic element which provides an elastic recovery force on the guiding arm to make the guiding arm return to the unexpanded state.

7. The disc-conveying structure of slot-in optical disc device according to claim 6, wherein guiding arms respectively have a guiding hole parallel to the slip direction of the guiding arm to correspond to the columns formed on the main chassis so as to restrict the guiding arms to slip in opposite directions and to avoid interference during expanding process.

8. The disc-conveying structure of slot-in optical disc device according to claim 6, wherein each guiding arm extends vertically downward to form a clamping bar and is confined to slip parallel to the loading slot.

9. The disc-conveying structure of slot-in optical disc device according to claim 5, wherein the limit switch is electrically connected to an on-off circuit of the roller device and mounted on an appropriate location of the main chassis, and when the guiding arm is selectively expanded and drawn back to a certain position, it triggers the limit switch to selectively start and close the power source of the roller device.

10. A disc-conveying structure of slot-in disc device, mainly an optical disc device for optical disc, at least comprising:
a switch device including a lock gate mechanism and a limit switch respectively disposed on the loading slot of the main chassis of the optical disc device, the lock gate mechanism being expanded by the insertion of the optical disc, the limit switch set up at a certain position in the expanding path of the lock gate mechanism, with the selectively expanding and drawing back of the lock gate mechanism to trigger the limit switch, the roller device selectively starting and closing the disc-conveying procedure.
a clamping device being as a caging mechanism for the optical disc to restrict the optical disc to be put in the correct working area A1 such that the optical disc is able to be accessed successfully by the disc read/write head.

11. The disc-conveying structure of slot-in optical disc device according to claim 10, wherein the lock gate mechanism has a plurality of guiding arms, which are restricted to slip in relatively straight directions, and a plurality of clamping bars are respectively extendedly formed on the relative ends of the guiding arms such that the clamping bars is able to cooperate with the insertion of the optical disc to expand the guiding arms, and a spur gear pivotally connected to the main chassis is meshed with the guiding arms, and at least one guiding arm is connected to an elastic element which provides an elastic recovery force on the guiding arm to make the guiding arm return to the unexpanded state.

12. The disc-conveying structure of slot-in optical disc device according to claim 11, wherein guiding arms respectively have a guiding hole parallel to the slip direction of the guiding arm to correspond to the columns formed on the main chassis so as to restrict the guiding arms to slip in opposite directions and to avoid interference during expanding process.

13. The disc-conveying structure of slot-in optical disc device according to claim 11, wherein each guiding arm extends vertically downward to form a clamping bar and is confined to slip parallel to the loading slot.

14. The disc-conveying structure of slot-in optical disc device according to claim 10, wherein the limit switch is electrically connected to an on-off circuit of the roller device and mounted on an appropriate location of the main chassis, and when the guiding arm is selectively expanded and drawn back to a certain position, it triggers the limit switch to selectively start and close the power source of the roller device.
